(19) United States
(12) Patent Application Publication
(10) Pub. No.: US 2007/0118493 A1
(43) Pub. Date: May 24, 2007

(54) Radio controlled model

(76) Inventor: Jonathan A. Jaffe, Voorhees, NJ (US)

Correspondence Address: KEUSEY, TUTUNJIAN & BITETTO, P.C., 20 CROSSWAYS PARK NORTH, SUITE 210, WOODBURY, NY, 11797, US

(21) Appl. No.: 11/603,629

(22) Filed: Nov. 22, 2006

Related U.S. Application Data
(60) Provisional application No. 60/739,125, filed on Nov. 23, 2005.

(51) Int. Cl. G06N 3/08

(52) U.S. Cl. 706/25

(57) ABSTRACT

A radio controlled model having removable training wings is provided. The training wings dampen the responsiveness to user controls and the operation of the same at speed. In addition to the training wings, a training mode of operation can be automatically or manually selected. The training mode is configured to modify the ranges of throw distances of the at least one control surface and/or modify the throttle limits, thereby increasing the model's stability by decreasing its sensitivity to slight movements in the control surfaces. In addition, the training mode may further modify the speed at which the control surfaces are moved and/or the throttle speed of a motor providing thrust to the model. This training mode assists a new user in learning the dynamics of the vehicle and its sensitivity to slight movements in the control surfaces, especially during flight.

### RELATED APPLICATION DATA

This application claims the benefit of priority from U.S. Provisional Application Ser. No. 60/739,125 filed on Nov. 23, 2005.

### BACKGROUND

1. Field of Technology

The present principles relate to radio controlled models. More particularly, they relate to models having multi-level modes of operation based on the skill of the user.

2. Description of the Related Art

Models that are capable of high degree of maneuverability on land or in the air, generally have a fixed size and shape which is specifically designed to aide in the model's ability to maneuver quickly.

Those of skill in the art will recognize that high speed operation of models having high degrees of maneuverability creates an entire new set of problems associated with the steering and maneuvering of the model. For example, during the high speed operation of a land vehicle, the slightest movement of the steering wheels will cause the model to react to such slight movement in an extreme manner. This same concept applies exponentially to flying models, where the control surfaces of the wings and any vertical stabilization are integral to the model's ability to fly, yet the slightest movement of any control surface will result in extreme reactions of the model's flight patterns. To the novice user, and even the intermediate user, such extreme reactions often result in crashing of the model.

An example of a high degree maneuverable model where these concepts are prevalent is the hydroplane. Model hydroplanes are designed to operate at high speeds on the water. At speed, the slightest movement of any of the control surfaces causes extreme changes in the model's behavior.

Newer generations of model hydroplanes add a flying attribute to the same by adding an air propulsion propellor and one or more sets of control surfaces. However, as mentioned above, when adding the flying attribute to the model hydroplane, the sensitivity in the movement of the control surfaces increases almost exponentially. The result is often multiple crashes of the model hydroplane, which can result in damage to the same, and frustration to the owner in their enjoyment.

Those of skill in the art will recognize and appreciate that it will be most difficult for beginners and new model owners to learn how to operate the same at high speeds and/or fly a model without crashing the same due to this inherent ultra-sensitivity to the movement of control surfaces.

### SUMMARY OF THE INVENTION

The present principles provide a model that includes a training mode of operation that reduces the inherent instability of the same.

The present principles further provide a model that includes at least one training wing to aide in training a novice user how to operate the model.

In other implementations, the model includes multi-level modes of operation for beginner, intermediate and advanced users.

These and other aspects are achieved in accordance with the present principles where the radio controller model includes a body, and at least one training wing releasably connected to the body for increasing stability of the model and dampening responsiveness to user input controls. In one implementation, the body further includes at least one movable control surface, and a receiver module having at least one actuating device for controlling the movement of the at least one control surface to enable steering and maneuvering of the model.

According to other implementations the receiver module further includes at least one training mode of operation configured to modify a throw range of one or more of said at least one movable control surface. The training mode can also be configured to: i) modify a throw range of one or more of said at least one movable control surface; and/or ii) modify a speed at which said at least one control surface is moved in response to a user input. In a further implementation, the training mode is configured to modify a throttle setting for a motor used to drive the model.

According to a further implementation, the transmitter includes an operation mode switch for selecting the at least one training mode of operation. In other implementations, the receiver module is configured to detect a position of the operation mode switch when the model is powered on and respond in accordance with the switch's detected position.

In further implementations, a detection device is provided to detect the presence of the at least one training wing. The detection device provides the receiver module with a control signal to enter the training mode of operation when the at least one training wing is present.

According to one method for operating a radio controlled model having a movable control surface for controlling the movement of the model and enabling steering and/or maneuvering of the model is provided. The method includes the steps of: providing at least one training wing releasably connectable to the model; identifying the activation of a training mode of operation; and modifying a throw range of one or more control surface in response to an activated training mode in order to increase model stability and dampening responsiveness to user input controls.

Other aspects and features of the present principles will become apparent from the following detailed description considered in conjunction with the accompanying drawings. It is to be understood, however, that the drawings are designed solely for purposes of illustration and not as a definition of the limits of the present principles, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings wherein like reference numerals denote similar components throughout the views:

FIG. 1 is a perspective view of the model according to an aspect of the present principles;

FIG. 2 is a perspective view of the model according to another aspect of the present principles;

FIG. 3 is a rear perspective view of the model according to an aspect of the present principles;

FIG. 4 is an exploded perspective view of the model according to an aspect of the present principles;

FIG. 5a is a perspective view of the receiver module with servos of the model according to an aspect of the present principles;

FIG. 5b is a perspective view of the transmitter module and receiver module with servos of the model according to an aspect of the present principles;

FIG. 6 is a perspective view of the model hydroplane with the training wings detached according to an aspect of the present principles;

FIG. 7 is a plan view of the training wing connection mechanism according to an aspect of the present principles;

FIG. 8a is a flow diagram of the training mode of operation of the model hydroplane according to an aspect of the present principles;

FIG. 8b is a flow diagram of the training mode of operation of the model hydroplane according to an another aspect of the present principles;

FIG. 8c is a cross sectional view of a sponson of the model hydroplane according to an aspect of the present principles;

FIG. 8d is a block diagram of the training mode of operation according to another aspect of the present principles;

FIG. 8e is an enlarged view of a training wing connection/support according to another aspect of the present principles;

FIG. 8f is an enlarged view of a training wing connection/support according to an aspect of the present principles;

FIG. 8g is a cross sectional view of a sponson of the model hydroplane according to another aspect of the present principles;

FIG. 9 is a flow diagram of the multi-level training mode operation of the model hydroplane according to an aspect of the present principles; and

FIG. 10 is a block diagram of the pulsed control system according to an aspect of the present principles.

### DETAILED DESCRIPTION

The present principles are herein described with reference to a model hydroplane. Those of skill in the art however, will recognize that these principles are applicable to all models designed to operate in a highly maneuverable fashion, and that the following model hydroplane implementation described herein is for exemplary purposes only and does not limit the application of the present principles to the same.

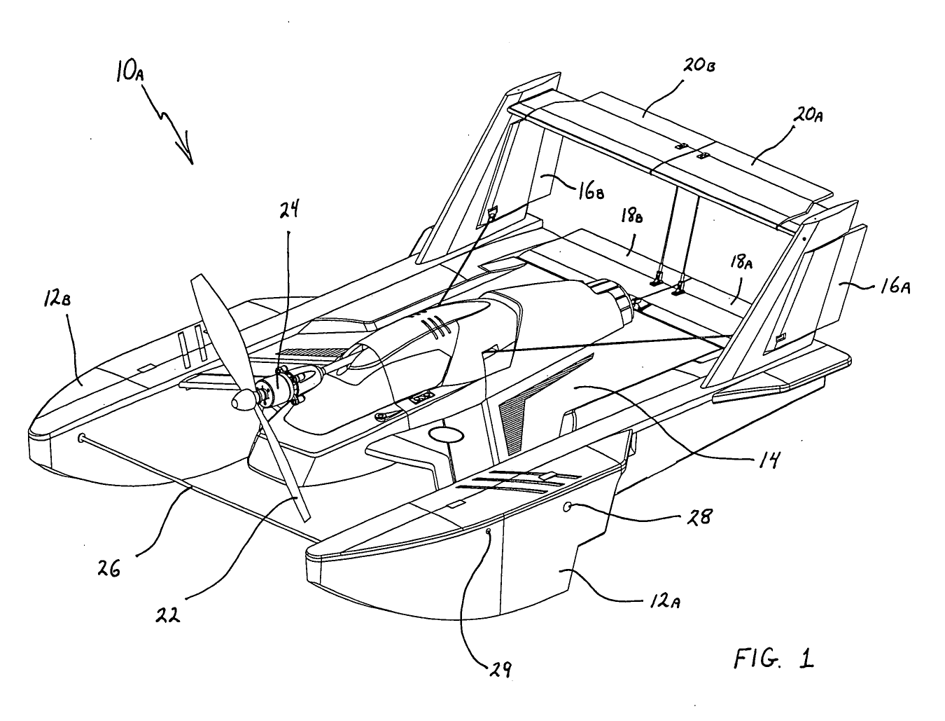

FIG. 1 shows a model 10a according to an aspect of the present principles. The model hydroplane 10a is a modular design and includes a body made up of sponsons (sponson modules) 12a and 12b that are connected to each other by a deck (module) 14. A plurality of control surfaces are used to steer and control the model during use. These control surface includes left and right rudders 16a and 16b, left and right lower elevons 18a and 18b, and left and right upper elevons 20a and 20b, respectively. A propeller 22 connected to a motor 24 provides the thrust for the model. According to one aspect, motor 24 is a brushless motor.

In accordance with one preferred implementation of the present principles, the model hydroplane and the corresponding sub-assembly modular parts are made of expanded polypropylene (EPP) tooled parts. EPP is a very durable and shapable material that provides increased impact strength with respect to low weights.

As will be apparent in the description of the present principles, the model hydroplane 10 is modularly designed such that the various sub-assemblies can be easily assembled by the user. The present principles utilize a combination of the EPP modular parts and strong carbon fiber rods (e.g., front rod 26, and connection rods 15 of the deck 14, and connection rods 68, 69 of the wings 30) to attach the sub-assemblies together and/or to reinforce other modular parts such as the deck, so as to provide significant impact strength and rigidity. This modular design and assembly allows for quick consumer disassembly for easy replacement of damaged parts, if necessary. It also allows the for individual high strength monocoque sub-assembly modules (e.g., sponsons modules 12), to be easily assembled with the other components (e.g., deck 14 and vertical stablizers 34 or rudders 16), into a complete unit, yet still allows for the sub-assembly modules to be easily replaced by the consumer.

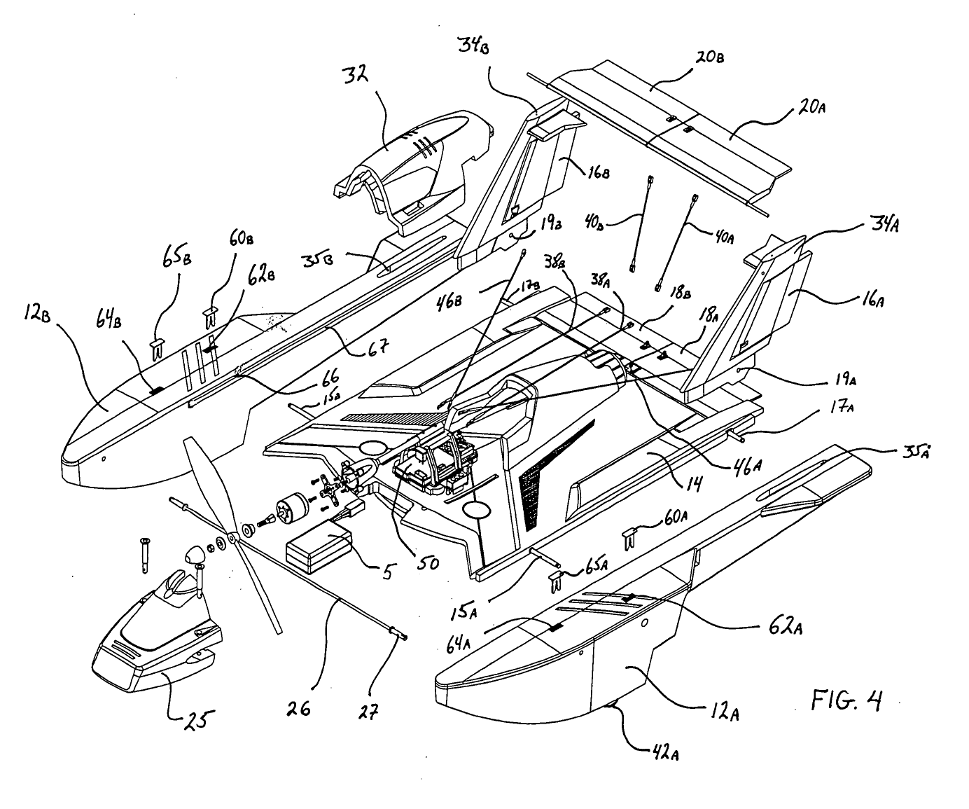

The individual parts of the model hydroplane 10 are further designed to inter digitate in order to increase the overall strength and integrity of the vehicle. Thus, the modular components are of an interlocking design that are supported and held together via a simple arrangement of high strength/light weight carbon fiber rods and tubes, with corresponding fittings. As shown in the exploded view in FIG. 4, the deck module 14 has edges that fit within the groove 67 in each sponson module 12. The vertical stabilizers 34 also mate with the upper and upper slot 35 in the sponson modules 12. The same concept is also shown for the fuselage cover 32 and its mating arrangement with a stationary portion of the fuselage 33 on the one end and the nose 25 on the other.

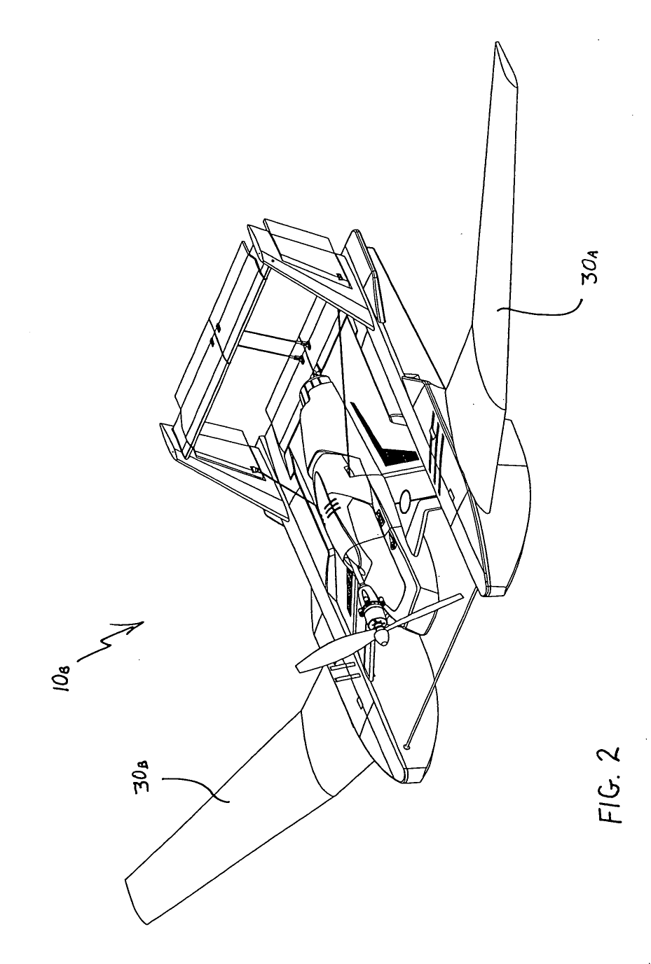

FIG. 2 shows the model hydroplane 10b according to another implementation of the present principles. As shown, training wings 30a and 30b are attached to the respective sponsons 12a and 12b.

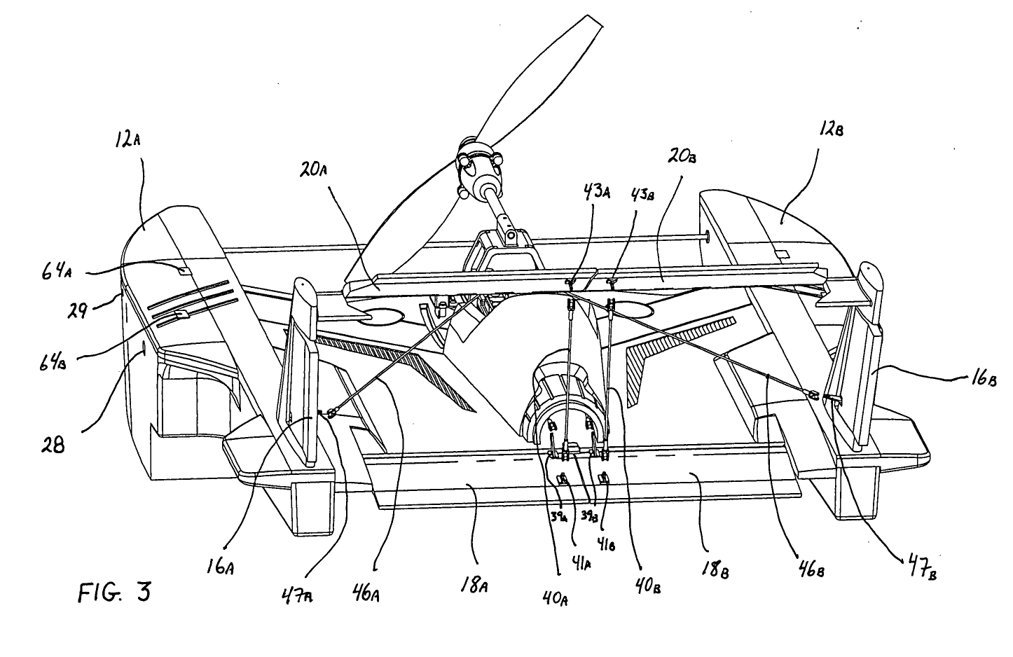

FIG. 3 shows a rear view of the model hydroplane according to the present principles. As shown, the lower elevons 18a and 18b are connected to the corresponding upper elevon 20a and 20b through control links 40a and 40b respectively. Control links 40a and 40b tie the upper and lower elevons together such that they move together in the same direction and under the control of the control rods 38a and 38b. The vertical stablizers 34a and 34b include rudders 16a and 16b that are connected to and move under the control of control rods 46a and 46b.

Referring to FIG. 4, there is shown the model hydroplane in an exploded perspective view. This view further enhances the modular aspect of the model and the respective sub-assemblies. For example, the deck module (sub-assembly) 14 includes outwardly extending connection rods 15a and 15b that are received by corresponding receiving holes 66 within a groove 67 on the inside surface of the sponsons 12. In one implementation, the connection rods 15 can include a snap fitting end 27 like that shown on front connection stabilizing bar 26. The receiving holes 66 in this case would be configured to receive the snap fitting end 27 and secure the deck to the corresponding sponson module 12 in a rigid manner. In other implementations, a deck lock clip 60a is received by the deck lock receiving hole 62a in the top of the sponson module 12a. The hole 62a is in communication with the receiving hole 66, and can enable the lock clip 60a to be inserted therein once the connection rod 15a is inserted in the receiving hole. In this manner, the integrity of the connection between the deck module 14 and sponson 12 can be further increased.

The connection rods 17a and 17b are an extension of the rotation axis of the lower elevons 18a and 18b. The rods 17a and 17b are received into corresponding receiving holes (not shown) in groove 67, and also pass through a hole 19 in the corresponding vertical stabilizer module 34, which portion is received by a slot in the upper surface of the sponson module 12. In this manner, the connection rods 17a and 17b secure the deck module 14 to the sponson modules 12, while at the same time, secures and retains the vertical stabilizer modules 34 in their vertical configuration with respect to the sponson modules 12.

FIG. 4 further shows the rudder control rods 46a and 46b, and the elevon control rods 38a and 38b. As mentioned above, the rudder control rods 46a and 46b are connected to the respective rudders 16a and 16b via clips 47a and 47b, respectively. In addition, the fuselage cover 32 is shown which operates to cover the receiver (RX) module 50. The control rods 38a and 38b are connected to the lower elevons 18a and 18b using clips 39a and 39b secured to the respective lower elevon 18a and 18b. The lower elevons 18a and 18b are connected to the upper elevons 20a and 20b using control links 40a and 40b, respectively. Control links 40a and 40b connect to the upper elevons 20a and 20b using clips 43a and 43b. Thus, through the actuation of the control rods 38a and 38b, the lower elevons 18a and 18b, and thereby upper elevons 20a and 20b are controlled such that the operate in unison with each other.

In accordance with one implementation, the sponsons 12a and 12b each includes a wheel or rub strip 42a and 42b (not shown). The wheels or rub strips 42 are configured to reduce any frictional contact between the ground and the lower surface of the sponsons 12.

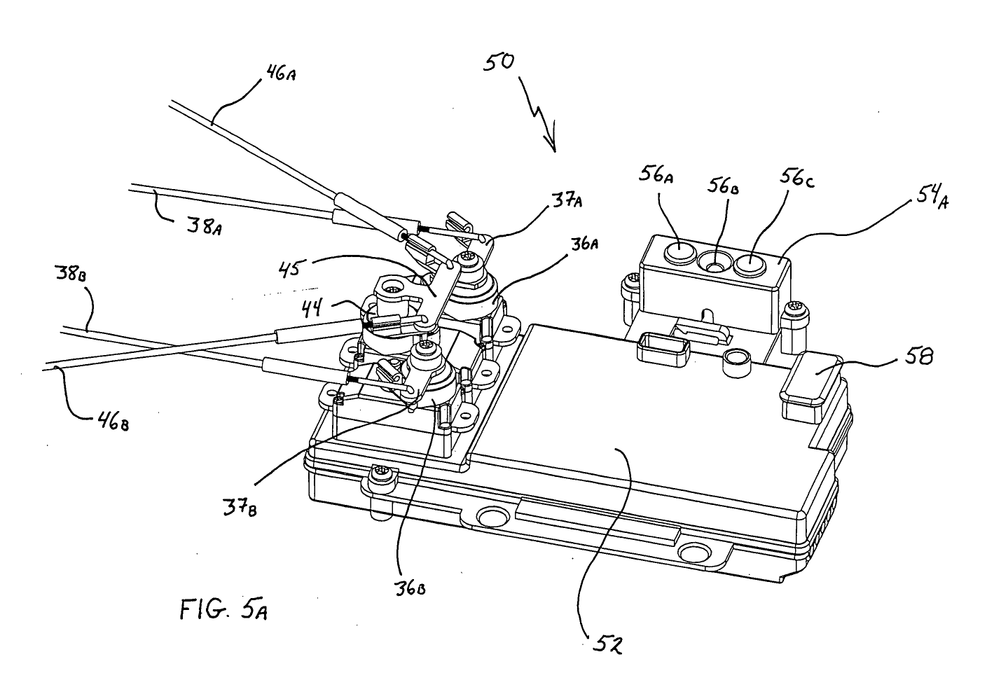

FIG. 5a shows the receiver (RX) module 50 according to an implementation of the present principles. The receiver module 50 includes a printed circuit board (PCB) (not shown) contained in the housing 52. The PCB is the brains of the model and provides the various functions through both hardware and software implementations. In accordance with one implementation, receiver module 50 includes a selector switch 54 having a plurality of switches and/or indicator lights 56a, 56b, 56c. One switch 56a establishes power connection between the battery 5 and the receiver module 50 and thereby the servos 36a, 36b and 44. Another switch 56c can operate as a safety switch to prevent unintentional starting of the motor and the associated injury risk. An indicator light 56b can be used with the switches 56a and 56c to indicate, for example, when the power is on, and when it is safe to start the model. In other implementations, the switches 56a and 56c could also be used to manually set a training mode or other multi-level mode of operation, discussed below.

A frequency crystal 58 is provided and as is commonly known in the art, can be replaced with other frequency crystals depending on the desired operating frequency.

Receiver module 50 further includes elevon servos 36a and 36b and a rudder servo 44. The two elevon servos 36a and 36b each have a corresponding horn 37a and 37b that is connected to the respective rudder control rod 46a and 46b. Through the use of separate servos 36a and 36b, the left (18a and 20a) and right (18b and 20b) elevons can be independently controlled. The rudder servo 44 includes a T-shaped horn 45 that is connected to both rudder control rods 46a and 46b. By connecting the control rods 46a and 46b to the horn 45 as shown, rotational movement in one direction of the horn will cause the two vertical rudders 16a and 16b to move in unison to control the turning and stunt maneuvers of the model. The operation of the servos 36 and 44 will be described in further detail below as it relates to the multi-level modes of operations of the present principles.

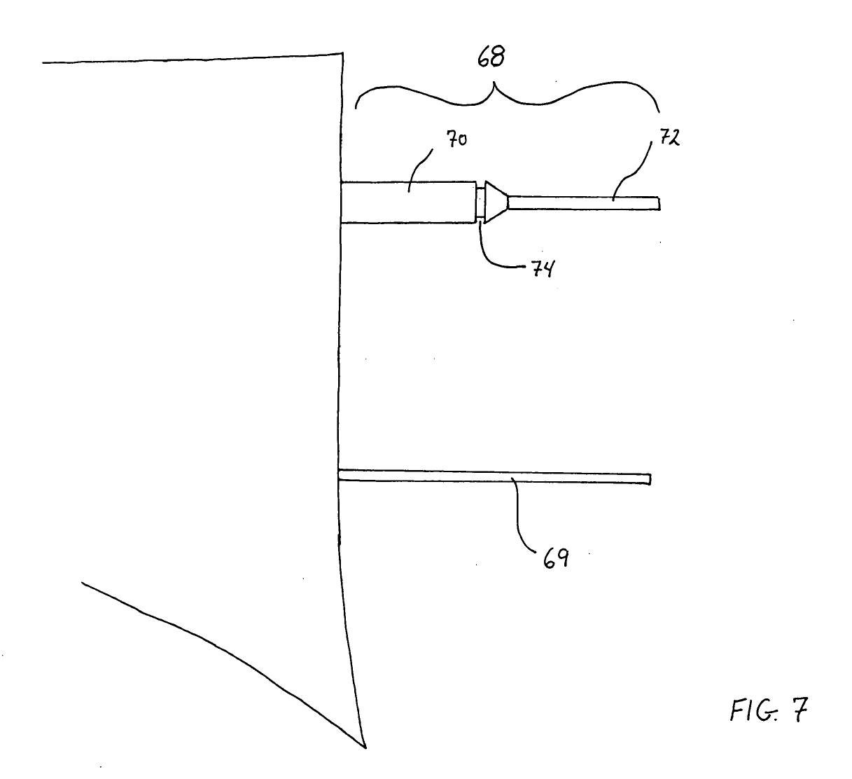

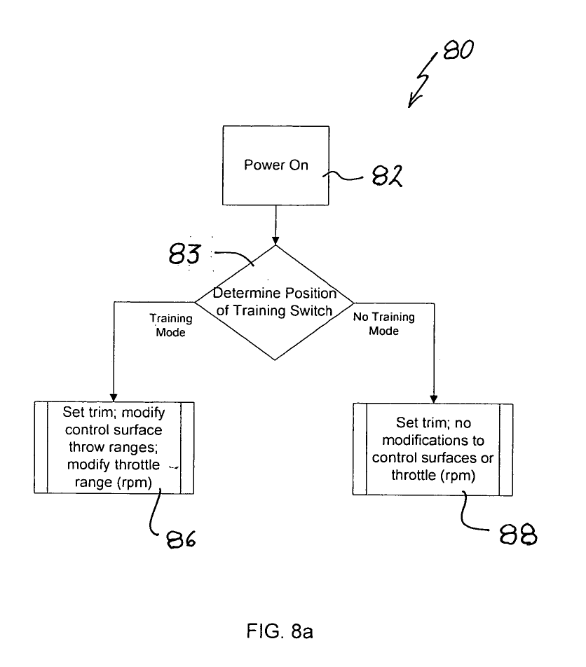

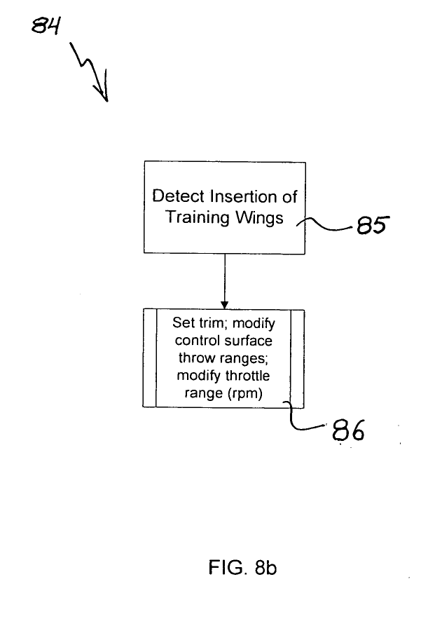

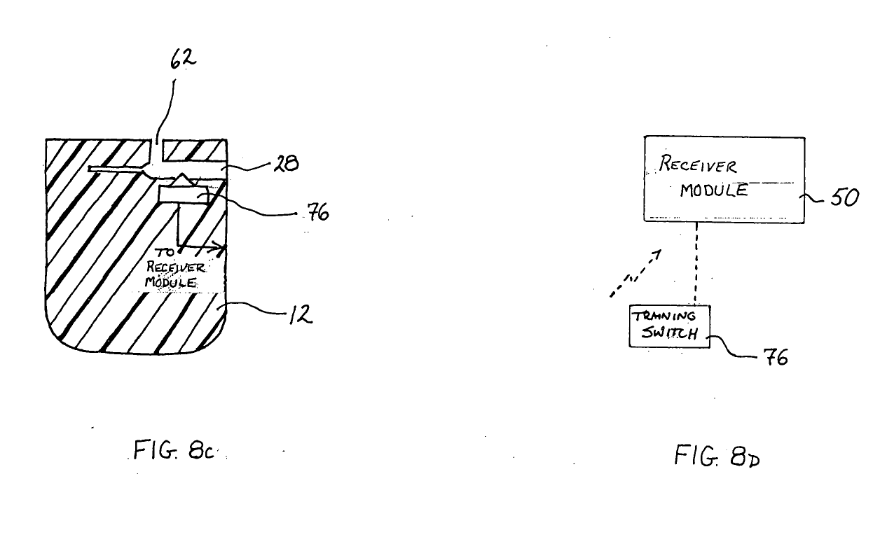

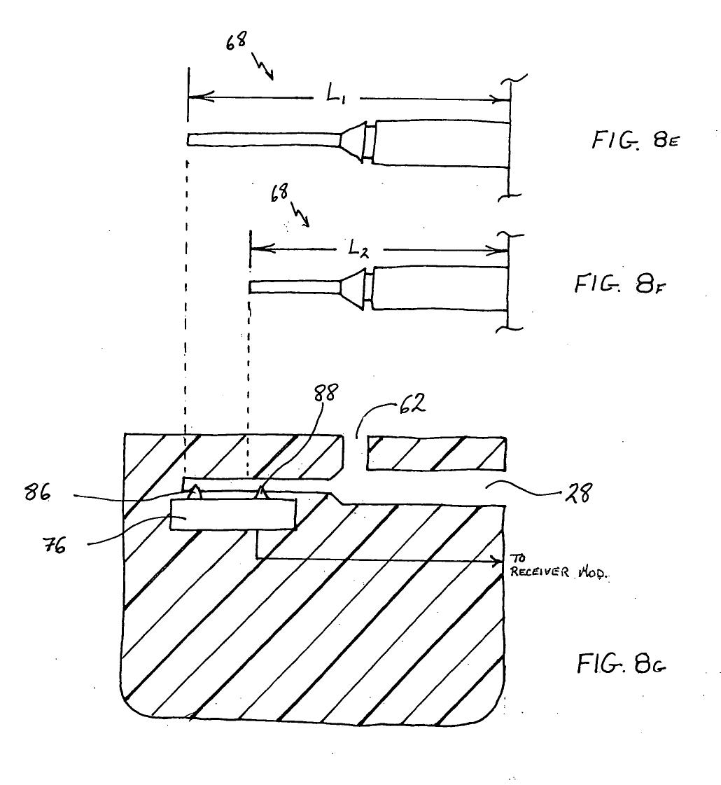

FIG. 5b shows another implementation of the model according to the present principles. As shown, a transmitter (TX) 104 wirelessly communicates with the receiver module 50 via antenna 106. Transmitter 104 includes controls 110L and 110R, and a training mode switch 108. The training mode switch 108 can be a toggle switch or a two pole button that triggers a control signal sent to the receiver module 50. Upon receipt of such a control signal, the receiver module 50 controls the servos 36a, 36b and 44 and thereby modifies the throw ranges of the various control surfaces of the elevons and rudders. This training mode is described in further detail below with respect to the implementations shown in FIGS. 8-10.

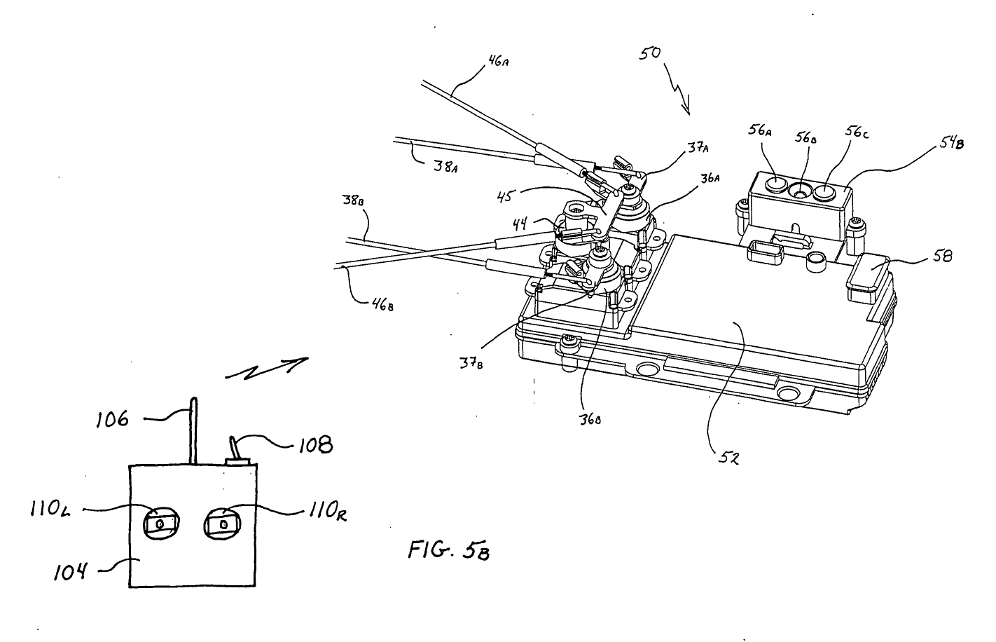

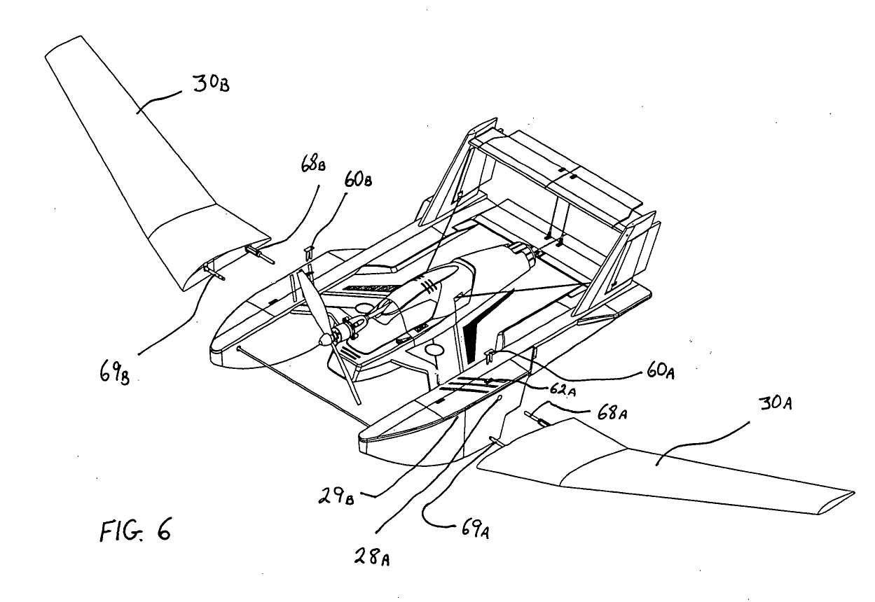

FIGS. 6 and 7 show the attachment of the training wings 30a and 30b to the model 10. The training wings 30a and 30b are designed for use by the beginner/novice operator and function to dampen the responsiveness to the controls, greatly improve the stability of the model during flight, and thereby increase the controllability. More specifically, the trainer wings 30 allow for a slower, more stable flight, due to the reduced wing loading and increased drag. The training wings 30 afford enough lift at lower power settings (i.e., throttle or rpm limit) such that when combined with modified control surface throw ranges (i.e., the “training mode”), it makes the model much easier for the beginner to learn how to operate and control.

By adding training wings 30, the stall speed of the model can be lowered, and the roll actions of the craft are significantly dampened, as compared to when it is operating in its smaller form without the training wings. When the operator becomes more experienced, the removal of the training wings will allow the more experienced pilot much higher maneuverability and roll rates, in addition to the ability to perform stunt maneuvers such as rapid vertical axial rolls, etc.

In order to add training wings 30, the wings include support/connection rods 68 and 69. These rods 68, 69 are received by correspondingly positioned holes 28, 29 in the sponson modules 12. According to one implementation, the support/connection rod 68 includes a first portion 70, a second portion 72, and a slot or groove 74 positioned between the first and second portions. The support/connection rods 68 and 69 are inserted simultaneously into the respective holes 28 and 29. In this implementation, the hole 28 is in communication with the wing lock receiving holes 62 such that once the support/connection rod 68 is full inserted into the hole 28, the wing lock clips 60 can be used to engage the slot 74 in the rod 68 and secure the same in a rigid manner to the sponsons. In the implementation shown, the connection rod 69 is shown as a straight rod that is not engaged by a locking clip or other locking mechanism. Those of skill in the art will recognize that an additional wing lock receiving hole and corresponding clip could be used on both support/connection rods, as deemed necessary for the desired application.

According to one implementation of the present principles, the insertion of the training wings 30 into the sponson modules 12 activates the “training mode” of operation.

In one preferred implementation, the model hydroplane has a multi-level mode of operation. The multi-level modes are primarily operation modes configured to assist a user in developing and honing their skill in operating the model to its fullest capability. In one example, the multi-level modes of operation can be: 1) Beginner; 2) Intermediate; and 3) Expert. These modes of operation can be manually activated by pressing a dedicated button (e.g. 56a, or 56c) depending on the desired mode. The pressing a manually operated button would cause the receiver module 50 (through servos 36 and 44) to first establish an initial trim position for the respective operation mode. This initial trim (i.e., neutral) position can be, for example an initial elevon position in a range of 1%-5%, and/or and initial rudder position in a range of 1%-5% based on the user level selected.

Once the initial trim position has been established, the receiver module 50 operates to control the servos 36 and 44 to modify the throw distance (i.e., range) of the control surfaces of the elevons 18, 20 and rudders 16 and proportionally lower throttle settings (i.e., rpm) accordingly. In addition to modifying the throw range of the control surfaces, receiver module 50 may also modify the speed at which the control surfaces move during operation.

By modifying the throw distances of the control surfaces of the elevons 18, 20 and vertical rudders 16, the sensitivity of the movement of the same is significantly reduced thereby eliminating the potential for an inexperienced user to accidentally move a control surface too far and cause the model to make extreme or erratic maneuvers that often result in loss of control and crashing. Thus, in a beginner mode, the throw range of the control surfaces can be modified for novice users by altering the usual throw range to be more or less in any one direction independent of the others, while in the intermediate mode, the throw range of the control surfaces could altered to be more or less in any one direction independent of the others as well, and in the expert mode, there would be no modifications on the throw range of the control surfaces or the speed at which the same operate. The modification of the throw ranges of the control surfaces of the elevons and rudders is performed through the receiver module's electronic control of the elevon and rudder servos 36a, 36b and 44, respectively.

In one implementation, the training mode can be established by the user from the radio controller 104. Referring to FIGS. 8a and 5b, the transmitter includes a training mode selector switch 108. When the receiver module 50 determines that the power is on 82, it determines what position 83 the training mode switch is in. When in “training mode” 86, the receiver module 50 responds by setting the trim; modifying the control surface throw ranges, and modifying the throttle range (i.e., constrain the r.p.m. of the motor). When no training mode is detected, the receiver module 50 responds by setting the trim and makes no further modifications to the control surfaces or throttle settings.

As mentioned above, in one implementation, the use of the training wings 30 can automatically cause the model to be set for the “training” or beginner mode of operation. Referring to FIG. 8b, the controller 50 is configured to detect the insertion of the training wings (85), and in response to such detection, modify the throw ranges of the control surfaces of the elevons and rudders for the training mode of operation. This may further include the lowering of throttle settings. The amount of the modifications on the throw ranges of the control surfaces for the training mode is predetermined and is ideally selected so as to assist the novice user in learning how to operate the model. In an exemplary implementation, the throws ranges of the elevons could be increased in one direction (e.g., downward), while being constrained in the other opposing direction (e.g., upward). While at the same time, the throttle range of the motor is lowered to, for example, 95%-50% of full power. Those of skill in the art will recognize that these throw range and throttle modification for a beginner or novice operation mode may vary from model to model without departing from the spirit of the present principles.

FIG. 8c shows a cross sectional diagram showing a switch 76 positioned within the hole 28 for receiving the training wing connection/support rod 68. The switch 76 is in communication with the receiver module 50, either by hard wire and plug, a wireless connection or other electromechanical connection, such that when the switch 76 is actuated by the insertion of support/connection rod 68, the receiver module 50 is instructed to enter the “training mode” of operation. This is shown by way of example in the block diagram of FIG. 8d where the receiver module 50 is either hard wired or wirelessly connected to switch 76.

In accordance with yet another implementation of the present principles, there can be different types of training wings, such as, for example, a long set (like that shown) for beginners, and a shorter or clipped wing version for the intermediate users. Thus, the entering of automatic modes of operation by inserting the training wings will require additional identification of the “type” of training wing attached. Those of skill in the art will recognize that there are many different ways to approach the identification of the type of wing attached without departing from the spirit of the present principles. By way of example, the connection/support rod 68 may have a different length for the beginner mode compared to that of the intermediate mode.

FIGS. 8e-8g show this concept. FIG. 8e shows the connection/support rod 68 having a length L1 that corresponds to the beginner training wing. FIG. 8f shows the connection/support rod 68 having a length L2 that corresponds to the intermediate training wing. FIG. 8g shows the receiving hole 28 with the switch 76 positioned therein. However, in this embodiment, switch 76 includes two actuating elements 86 and 88, which are spaced from each other. Thus, when the beginner training wing having the connection/support rod 68 with the length L1 is inserted into receiving hole 28, the length of the rod will engage both actuators 86 and 88. Switch 76 can be configured such that when both actuators 86 and 88 are engaged, the switch 76 sends a signal to receiver module 50 indicating that the beginner training wings have been inserted and the beginner training mode should be automatically activated. Correspondingly, when the shorter length L2 connection/support rod 68 is inserted into receiving hole 28, its shorter length will only engage actuator 88. Switch 76 responds to the engagement of the single actuator 88 and recognized the same as the intermediate training wing, and in response, sends a signal to the receiver module 50 indicating that the intermediate training mode should be automatically activated.

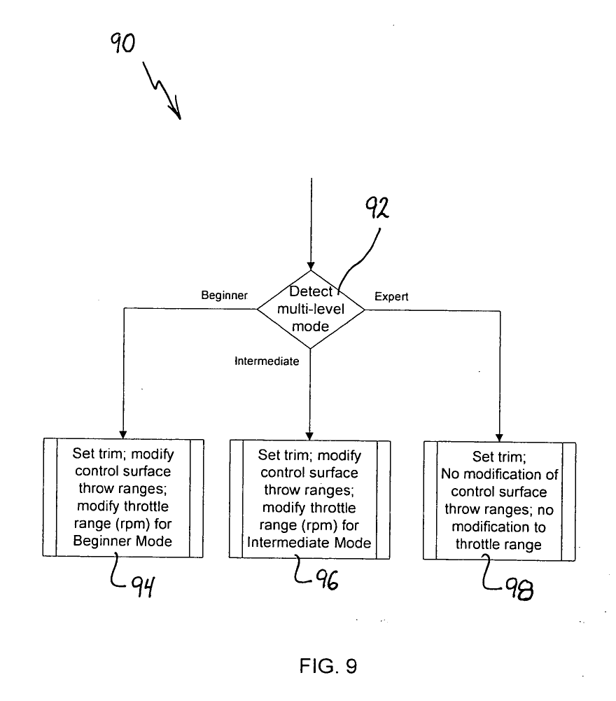

The multi-level mode of operation 90 is now described with reference to FIG. 9. Initially, the multi-level mode is detected 92. This detection can be provided in any manner as described above. For example, operation of a switch 108 on the transmitter, actuation of a manual switch (e.g., 56a, 56c) on the body of the model, or alternatively can be through the insertion of the training wings 30. As discussed above, depending on the selected mode of operation the receiver module 50 will: 1) modify the throw ranges of the control surfaces of the elevons and/or rudders; 2) modify the throttle settings of the motor; and/or 3) modify the speed at which the control surfaces move in response to the user commands.

Thus, when beginner mode is entered, the ranges of specific control surfaces for beginner mode are set 94. For example, the initial trim is set, the control surface throw ranges are modified and the throttle settings are also modified. This initial trim (i.e., neutral) position can be, for example an initial elevon position in a range of 1%-5% elevon and/or 1%-5% rudder depending on the user level selected. Examples of throw ranges modifications can include, for example, 20%-40% increase or decrease in the throw range in any one direction. Similarly, for intermediate mode, the initial trim is set, the throw ranges of control surfaces are modified and any throttle restrictions are implemented 94. For example, in this intermediate mode, the throw ranges for the controller surfaces can be, for example, in a range of 40%-70% increase or decrease in the throw range in any one direction. In the expert mode of operation, there need not be any limitation on the throw ranges of the control surfaces, and as such, this mode can simply enable the corresponding servos to operate freely without restriction or limitation.

In accordance with another implementation of the present principles, the training mode and/or other multi-level modes of operation, the speed at which the control surfaces of the elevons and rudders are moved can have a drastic effect on the controllability of the model. As such, for example, in the training (beginner) mode or intermediate modes of operation, not only is it desireable to limit the throw ranges of the elevons and/or rudder control surfaces, but the speed as which they are moved while operating in those modes. As will be described below, the training mode can also include a throttle limit or constraint on the motor rpm.

In order to achieve a reduction in the speed at which the control surfaces are moved by the respective servos 36a, 36b and 44, a pulsed control is implemented. By pulsing the control signals to the servos, the speed of movement of the control surfaces connected to the respective servos is reduced, and thus the potential for erratic behavior of the model is significantly reduced.

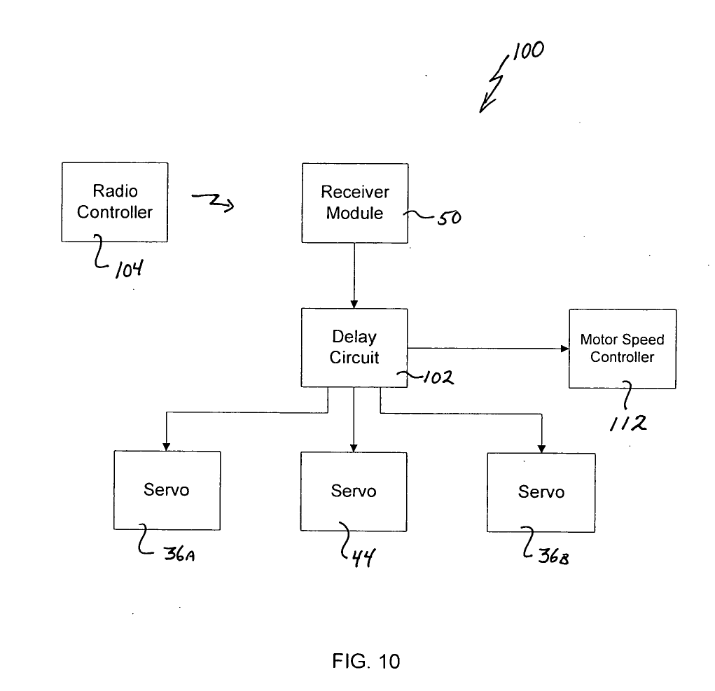

As briefly described above, and in normal operation, the receiver module 50 receives wireless commands from a radio controller 104 (FIGS. 5b and 10). The receiver module 50 interprets the received signals and provides the appropriate voltage control signals to the servos 36a, 36b and 44 to provide the requested movement. FIG. 10 shows a block diagram of the apparatus 100 for controlling the speed of movement of the control surfaces according to an implementation of the present principles. As shown, a delay circuit 102 is added between the receiver module 50 and the servos 36a, 36b and 44. The delay circuit operates to delay or pulse the control voltages to the respective servos, thereby causing the same to move in a slower, more predictable manner. According to one preferred implementation of the present principles, this pulsing of the control voltages to the servos may be used in conjunction with the modified throw distances of the training (beginner) and intermediate modes of operation. By combining the reduction in the speed of the control surface movement with the modified throw distances of the same, a user can literally learn how to optimize and utilize all of the model's stunt and flying capabilities without damaging or breaking the model in the process.

In other contemplated implementations, the delay 102 is applied to the motor speed controller 112 to effect the throttle reductions or modifications required for the training and/or intermediate modes of operation.

In an alternative implementation, the delay provided by circuit 102 can be provided through software programming of a processor contained within receiver module 50 and/or PCB 52. In this software solution, the receiver module 50 would provide the pulsed or delayed control signals under instruction of a processor or other computing device.

It is to be further understood that, because some of the constituent system components and method steps depicted in the accompanying Figures are preferably implemented in software, the actual connections between the system components (or the process steps) may differ depending upon the manner in which the present principles is programmed. Given the teachings herein, one of ordinary skill in the related art will be able to contemplate these and similar implementations or configurations of the present principles.

While there have been shown, described and pointed out fundamental novel features of the present principles, it will be understood that various omissions, substitutions and changes in the form and details of the methods described and devices illustrated, and in their operation, may be made by those skilled in the art without departing from the spirit of the same. For example, it is expressly intended that all combinations of those elements and/or method steps which perform substantially the same function in substantially the same way to achieve the same results are within the scope of the present principles. Moreover, it should be recognized that structures and/or elements and/or method steps shown and/or described in connection with any disclosed form or implementation of the present principles may be incorporated in any other disclosed, described or suggested form or implementation as a general matter of design choice. It is the intention, therefore, to be limited only as indicated by the scope of the claims appended hereto.

What is claimed is:

1. A radio controlled model comprising:
a body; and
at least one training wing releasably connected to the body for increasing stability of the model and dampening responsiveness to user input controls.

2. The model of claim I, wherein said body further comprises:
at least one movable control surface; and
a receiver module with an actuating device for controlling the movement of the control surfaces to enable steering and maneuvering of the model.

3. The model of claim 2, wherein said receiver module further comprises at least one training mode of operation configured to modify a throw range of one or more of said at least one movable control surface.

4. The model of claim 2, wherein said receiver module further comprises at least one training mode of operation configured to: i) modify a throw range of one or more of said at least one movable control surface; and ii) modify a speed at which said at least one control surface is moved in response to a user input.

5. The model of claim 3, further comprising a motor connected to said body and configured to provide thrust to the model in response to user input, said training mode of operation further configured to modify a throttle setting for the motor in response to said training mode of operation.

6. The model of claim 4, further comprising a motor connected to said body and configured to provide thrust to the model in response to user input, said training mode of operation further configured to modify a throttle setting for the motor in response to said training mode of operation.

7. The model of claim 3, further comprising a transmitter for transmitting control signals to the receiver module, said transmitter having an operation mode switch for selecting the at least one training mode of operation.

8. The model of claim 7, wherein said receiver module is configured to detect a position of said operation mode switch when the model is powered on and respond in accordance with the switch's detected position.

9. The model of claim 3, further comprising a detection device for detecting the presence of the at least one training wing, said detection device providing said receiver module with a control signal to enter the training mode of operation when the at least one training wing is present.

10. The model of claim 1, further comprising a connection mechanism for releasably and securely connecting the at least one training wing to the body.

11. The model of claim 2, further comprising a connection mechanism for releasably and securely connecting the at least one training wing to the body, said connection mechanism comprising:
at least one support/connection member extending from a connection end of said at least one training wing;
at least one corresponding connection portion in the body configured to receive the at least one support/connection member; and
a securing device in communication with the at least one connection portion for releasably securing the at least one support/connection member when connected there to.

12. A method for operating a radio controlled model having a movable control surface for controlling the movement of the model and enabling steering and/or maneuvering of the model, the method comprising the steps of:
providing at least one training wing releasably connectable to the model;
identifying the activation of a training mode of operation; and
modifying a throw range of one or more control surface in response to an activated training mode in order to increase model stability and dampening responsiveness to user input controls.

13. The method of claim 12, wherein said identifying further comprises receiving a control signal from a transmitter indicating the training mode activation.

14. The method of claim 12, wherein said identifying further comprises detecting the presence of the at least one training wing when connected to the model.

15. The method of claim 14, wherein said detecting further comprises identifying a type of training wing attached to the model and in response to said identification, said modifying being performed in a predetermined configuration corresponding to the identified type of training wing attached.

16. The method of claim 14, wherein said detecting further comprises identifying one of at least two different types of training wings attached to the model

17. The method of claim 12, wherein said modifying further comprises modifying a speed at which said control surface is moved during operation in the training mode.

18. The method of claim 12, wherein said modifying further comprising modifying a throttle speed of a motor during operation in the training mode.
